(19) United States
(12) Patent Application Publication
(10) Pub. No.: US 2007/0098361 A1
(43) Pub. Date: May 3, 2007

(54) Broadcasting signal recording/playing system, broadcasting signal recording/playing apparatus and broadcasting signal tuning apparatus

(75) Inventor: Sang-chul Shin, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/592,294

(22) Filed: Nov. 3, 2006

(30) Foreign Application Priority Data
Nov. 3, 2005 (KR) 10-2005-0105053

(51) Int. Cl. H04N 5/91

(52) U.S. Cl. 386/83

(57) ABSTRACT

A broadcasting signal recording/playing system and method are provided, including a storage apparatus which stores a broadcasting signal therein; a playing apparatus which processes the broadcasting signal and outputs it; and a broadcasting signal tuning apparatus which has a broadcasting signal tuning unit to tune the broadcasting signal, and a recording/playing controller to output a control signal and the broadcasting signal according to a predetermined recording/playing signal to at least one of the storage apparatus and the playing apparatus if the broadcasting signal is received and the predetermined recording/playing signal is supplied. Thus, A broadcasting signal recording/playing system in which a broadcasting tuning apparatus having a broadcasting signal tuner controls respective apparatuses if apparatuses which record and play a broadcasting signal are divided, a broadcasting signal recording/playing apparatus and a broadcasting signal tuning apparatus are provided.

### CROSS-REFERENCE TO RELATED APPLICATIONS

This application claims priority from Korean Patent Application No. 2005-0105053, filed on Nov. 3, 2005, in the Korean Intellectual Property Office, the disclosure of which is incorporated herein by reference.

### BACKGROUND OF THE INVENTION

1. Field of the Invention

Apparatuses and methods consistent with the present invention relate to a broadcasting signal recording/playing system, a broadcasting signal recording/playing apparatus and a broadcasting signal tuning apparatus, and more particularly, to a broadcasting signal recording/playing system which records and plays a broadcasting signal, a broadcasting signal recording/playing apparatus and a broadcasting signal tuning apparatus.

2. Description of the Related Art

As digital broadcasting technology has been rapidly developed, a personal video recorder (PVR) which employs a storage device such as a hard disk driver (HDD) as an image storage medium is being popular in incorporation with computer technology. The PVR comprises a personal moving picture storage apparatus which stores a received broadcasting signal in the HDD instead of an existing videotape, in a digital method.

The PVR may record a public broadcasting, a cable broadcasting and a satellite broadcasting in the digital method. The PVR may record the broadcasting until it receives a playing command if a pause signal is input while playing the broadcasting signal. Accordingly, a viewer may view the broadcasting from a time when he/she presses a pause button even if the predetermined time has passed after pressing the pause button. The broadcasting signal from a time when the pause button is pressed to the time when the playing command is input may be stored in a storage device such as the HDD.

The related art broadcasting signal recording/playing apparatus such as the PVR comprises a broadcasting signal receiver which receives the broadcasting signal; a storage unit such as an HDD; and a broadcasting signal playing unit which processes a broadcasting signal received through the broadcasting receiver, to be displayed, in a single apparatus.

Thus, the related art broadcasting signal recording/playing apparatus such as the PVR does not separately provide the respective parts which record and play the broadcasting signal, except the display unit.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Accordingly, it is an aspect of the present invention to provide a broadcasting signal recording/playing system in which a broadcasting tuning apparatus having a broadcasting signal tuner controls respective apparatuses if apparatuses which record and play a broadcasting signal are divided, a broadcasting signal recording/playing apparatus and a broadcasting signal tuning apparatus.

Additional aspects of the present invention will be set forth in the description which follows.

The foregoing and/or other aspects of the present invention provide a broadcasting signal recording/playing system, the system comprising a storage apparatus which stores a broadcasting signal therein; a playing apparatus which processes the broadcasting signal to be played and outputs it; and a broadcasting signal tuning apparatus which has a broadcasting signal tuning unit to tune the broadcasting signal received from the outside, and a recording/playing controller to output a control signal and the broadcasting signal according to a recording/playing signal to at least one of the storage apparatus and the playing apparatus if the broadcasting signal is received and the predetermined recording/playing signal is supplied.

According to another aspect of the present invention, the recording/playing signal comprises at least one of a recording signal and a playing signal, and wherein the recording/playing controller outputs the broadcasting signal tuned by the broadcasting signal tuning unit to the storage apparatus, and controls the storage apparatus to store the output broadcasting signal therein, if the recording signal is supplied.

According to another aspect of the present invention, the recording/playing controller controls the storage apparatus to store the broadcasting signal received through the broadcasting signal tuning unit, and controls the storage apparatus to output the broadcasting signal stored in the storage apparatus to the playing apparatus, if the playing signal is supplied and the storage apparatus stores the broadcasting signal therein.

According to another aspect of the present invention, the recording/playing controller controls the storage apparatus to store the broadcasting signal received through the broadcasting signal tuning unit, and reads the broadcasting signal stored in the storage apparatus to output it to the playing apparatus, if the playing signal is supplied and the storage apparatus stores the broadcasting signal therein.

According to another aspect of the present invention, the recording/playing controller outputs the broadcasting signal received through the broadcasting signal tuning unit to the playing apparatus if the playing signal is supplied and the storage apparatus does not store the broadcasting signal therein.

According to another aspect of the present invention, the broadcasting signal recording/playing system further comprises a display apparatus which has a display unit to display an image thereon based on the broadcasting signal processed by the playing apparatus to be played.

According to another aspect of the present invention, the broadcasting signal recording/playing system further comprises a user selection unit which is provided in at least one of the display apparatus, the storage apparatus, the playing apparatus and the broadcasting signal tuning apparatus, and selects at least one of the recording signal and the playing signal to be supplied to the recording/playing controller.

The foregoing and/or other aspects of the present invention also provide a broadcasting signal tuning apparatus comprising a broadcasting signal tuning unit which receives and tunes a broadcasting signal; a communication unit which communicates with a predetermined external device; and a recording signal controller which supplies a control signal according to a recording/playing signal to the external device through the communication unit if the broadcasting signal is received and the predetermined recording/playing signal is supplied.

According to another aspect of the present invention, the recording/playing signal comprises at least one of a recording signal and a playing signal, and wherein the recording/playing controller outputs the broadcasting signal and the control signal to store the broadcasting signal, to the external device if the recording signal is supplied.

According to another aspect of the present invention, the recording/playing controller outputs the broadcasting signal received through the broadcasting signal tuning unit and the control signal to store the broadcasting signal, to the external device and outputs the control signal to the external device to play the broadcasting signal stored in the external device, if the playing signal is supplied and it is determined that the broadcasting signal is stored in the external device.

According to another aspect of the present invention, the recording/playing controller outputs the broadcasting signal received through the broadcasting signal tuning unit and the control signal to play the broadcasting signal, to the external device, if the playing signal is supplied and it is determined that the broadcasting signal is not stored in the external device.

According to another aspect of the present invention, the broadcasting signal tuning apparatus further comprises a user selection unit which selects at least one of a recording operation and a playing operation, and wherein the recording/playing controller receives the recording signal if the recording operation is selected through the user selection unit, and receives the playing signal if the playing operation is selected through the user selection unit.

According to another aspect of the present invention, the communication unit receives the recording/playing signal from the external device.

The foregoing and/or other aspects of the present invention also provide a broadcasting signal recording/playing apparatus comprising a communication unit which communicates with a predetermined external device to store a broadcasting signal; a broadcasting signal tuning unit which receives and tunes the broadcasting signal; a playing unit which processes the broadcasting signal to be played and outputs it; and a recording/playing controller which outputs at least one of the broadcasting signal and a control signal according to a recording/playing signal, to at least one of the external device and the playing unit if the broadcasting signal is received and the predetermined recording/playing signal is supplied.

According to another aspect of the present invention, the recording/playing signal comprises at least one of a recording signal and a playing signal, and wherein the recording/playing controller outputs the broadcasting signal and the control signal which controls the external device to store the output broadcasting signal, to the storage apparatus if the recording signal is supplied.

According to another aspect of the present invention, the recording/playing controller outputs the control signal to store the broadcasting signal received through the broadcasting signal tuning unit, to the external device, and outputs the control signal to output the broadcasting signal stored in the external device to the playing unit, to the external device if the playing signal is supplied and the external device stores the broadcasting signal therein.

According to another aspect of the present invention, the recording/playing controller controls the broadcasting signal received through the broadcasting signal tuning unit to be output to the playing unit if the recording signal is supplied and the external device does not store the broadcasting signal therein.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is a control block diagram of a broadcasting signal recording/playing system according to a first exemplary embodiment of the present invention;

FIG. 2 is a control block diagram of a broadcasting signal recording/playing system according to a second exemplary embodiment of the present invention; and

FIG. 3 is a control flowchart of the broadcasting signal recording/playing system according to the exemplary embodiment of the present invention.

### DETAILED DESCRIPTION OF THE EXEMPLARY EMBODIMENTS

Reference will now be made in detail to the exemplary embodiments of the present invention, examples of which are illustrated in the accompanying drawings, wherein like reference numerals refer to like elements throughout.

### First Exemplary Embodiment

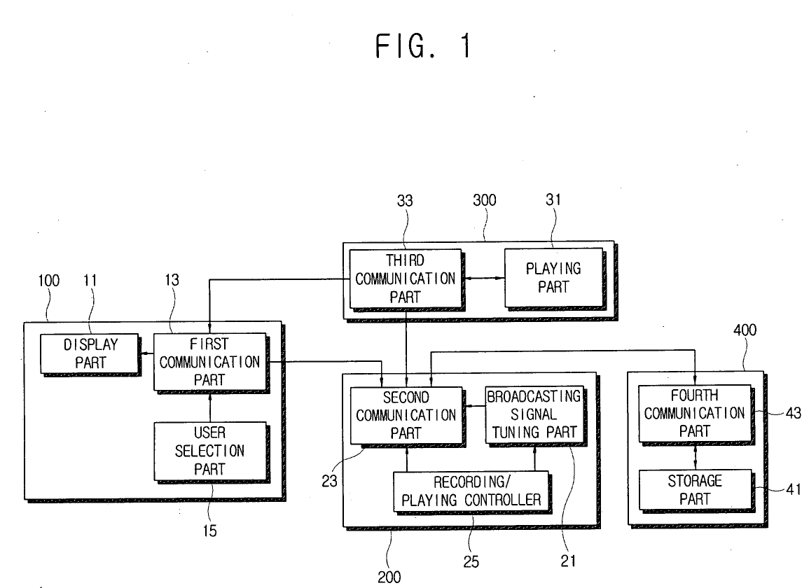

As shown in FIG. 1, a broadcasting signal recording/playing system according to a first exemplary embodiment of the present invention comprises a broadcasting signal tuning apparatus 200 which has a broadcasting signal tuning unit 21 to tune a broadcasting signal, a storage apparatus 400 which has a storage unit 41 to store the broadcasting signal therein, and a playing apparatus 300 which has a playing unit 31 to process the broadcasting signal to be played. The broadcasting signal recording/playing system may further comprise a display apparatus 100 which has a display unit 11.

At least one of the respective apparatuses of the broadcasting signal recording/playing system comprises a user selection unit 15 which inputs a predetermined input signal.

The user selection unit 15 outputs a predetermined key signal to a recording/playing controller 25 of the broadcasting signal tuning apparatus 200 (to be described later) according to a user's manipulation. The user selection unit 15 may comprise a plurality of input keys, a button or a remote control to input or select a predetermined operation by a user. The user selection unit 15 according to the exemplary embodiment of the present invention may output a recording/playing signal which comprises at least one of a recording signal and a playing signal to the recording/playing controller 25 of the broadcasting signal tuning apparatus 200 (to be described later) by a user's selection.

If a user wants to store the broadcasting signal in the storage apparatus 400, e.g., if a pause button is selected, the recording signal is output. If a user wants to play the broadcasting signal, e.g., if a play button is selected, the playing signal is output.

As an example of the exemplary embodiment of the present invention, the user selection unit 15 is provided in the display apparatus 100, but not limited thereto. Alternatively, the user selection unit 15 may be provided in one of the broadcasting signal tuning apparatus 200, the storage apparatus 400 and the playing apparatus 300, other than the display apparatus 100. The position of the user selection unit 15 is not limited as long as the user selection unit 15 is provided in one of the respective apparatuses of the broadcasting signal recording/playing system.

The display apparatus 100 according to the exemplary embodiment of the present invention comprises the display unit 11 which displays a predetermined image thereon, and a first communication unit 13 which communicates with an external device.

Here, the display unit 11 receives the broadcasting signal output from the playing apparatus 300 (to be described later) to display an image thereon. The display unit 11 comprises a display module (not shown) which displays an image thereon, and a module driver (not shown) which processes the input broadcasting signal to display an image on the display module.

The display module according to the exemplary embodiment of the present invention may comprise various display modules including a cathode ray tube (CRT), a digital light processing (DLP), a liquid crystal display (LCD) and a plasma display panel (PDP). Here, if the DLP is provided as the display module, the module driver comprises an optical engine. If the LCD is provided as the display module, the module driver comprises a printed circuit board (PCB) which converts an image signal input from a color converter into a data signal and a gate signal. Also, the display unit 11 may vary according to the type of the display module.

The first communication unit 13 comprises a communication module and a communication terminal through which a communication signal is transmitted. The first communication unit 13 is connected with a third communication unit 33 of the playing apparatus 300 (to be described later) and receives the broadcasting signal which is processed to be displayed.

The first communication unit 13 may further comprise a terminal which communicates with a second communication unit 23 of the broadcasting signal tuning apparatus 200 (to be described later) other than the terminal connected with the playing apparatus 300. If the user selection unit 15 is provided in the display apparatus 100, the first communication unit 13 may communicate with the second communication unit 23 to supply the input signal transmitted through the user selection unit 15 to the broadcasting signal tuning apparatus 200. Here, the first communication unit 13 may communicate with the second communication unit 23 through an IEEE 1394, Ethernet or wireless method. The first communication unit 13 may communicate with the third communication unit 33 through the same method as the second communication unit 23, but not limited thereto. Alternatively, the first communication unit 13 may communicate through another communication method if the terminal is additionally provided.

The storage apparatus 400 according to the exemplary embodiment of the present invention comprises a fourth communication unit 43 which communicates with the external device, and the storage unit 41 which stores a predetermined broadcasting signal therein.

Here, the fourth communication unit 43 communicates with the second communication unit 23 of the broadcasting signal tuning apparatus 200 (to be described later) and may be provided as the same standard as the second communication unit 23. For example, the fourth communication unit 43 may communicate with the second communication unit 23 through an IEEE 1394, Ethernet or wireless method. The storage unit 41 may comprise a memory such as a hard disk drive (HDD). Here, the storage apparatus 400 comprises an external HDD as an example of the exemplary embodiment of the present invention.

The playing apparatus 300 according to the exemplary embodiment of the present invention comprises the third communication unit 33 which communicates with the external device, and the playing unit 31 which processes the predetermined broadcasting signal to be played.

The playing unit 31 processes the broadcasting signal corresponding to a channel tuned by the broadcasting signal tuning unit 21 (to be described later) into a playable signal. Here, the playing unit 31 may comprise at least one of broadcasting signal processing devices such as a scaler or a decoder, to process the broadcasting signal.

The third communication unit 33 comprises a communication module and a communication terminal through which a communication signal is transmitted. The third communication unit 33 is connected with the second communication unit 23 of the broadcasting signal tuning apparatus 200 to receive the broadcasting signal.

The third communication unit 33 may comprises the terminal alone which is connected with the broadcasting signal tuning apparatus 200. However, the third communication unit 33 preferably comprises a terminal which communicates with the first communication unit 13 of the display apparatus 100 (to be described later). That is, the playing apparatus 300 may supply the processed broadcasting signal to be played, to the display apparatus 100 through the broadcasting signal tuning apparatus 200. Also, the playing apparatus 300 may comprise the terminal to output the processed broadcasting signal to the display apparatus 100 directly. Here, the third communication unit 33 may communicate with the second communication unit 23 through an IEEE 1394, Ethernet or wireless method. The third communication unit 33 may communicate with the first communication unit 13 in the same method as the second communication unit 23. If an additional terminal is provided, the third communication unit 33 may communicate with the first communication unit 13 through another communication method.

The broadcasting signal tuning apparatus 200, e.g., a tuner comprises the second communication unit 23 which communicates with a communication unit of the external device, the broadcasting signal tuning unit 21 which tunes the broadcasting signal, and the recording/playing controller 25.

As described above about the first communication unit 13, the second communication unit 23 may also communicate through an IEEE 1394, Ethernet or wireless method. If necessary, the second communication unit 23 may communicate with the third and fourth communication parts 33 and 43, as well as with the first communication unit 13. Also, the second communication unit 23 may communicate through another communication method, other than the foregoing communication methods, as long as it is a standard communicable with other communication parts. The second communication unit 23 may comprise a plurality of terminals which are connected with the respective apparatuses.

The broadcasting signal tuning unit 21 tunes a predetermined channel among a plurality of channels received through an antenna (not shown), according to a tuning control signal supplied from the recording/playing controller 25 (to be described later). Here, the broadcasting tuning unit 21 comprises an antenna and a unit which receives and tunes the broadcasting signal.

If the broadcasting signal comprises an analog signal, the broadcasting signal tuning apparatus 200 may further comprise an MPEG codec (not shown) which compresses the analog broadcasting signal to be output as MPEG data; and an analog/digital (AD) converter (not shown) which converts the analog signal into a digital signal.

The recording/playing controller 25 controls the broadcasting signal tuning unit 21 to tune the predetermined channel according to an input signal or stored data of the user selection unit 15.

If the broadcasting signal is received through the broadcasting signal tuning unit 21 and a predetermined recording/playing signal is supplied, the recording/playing controller 25 outputs a control signal and a broadcasting signal according to the recording/playing signal, to at least one of the storage apparatus 400 and the playing apparatus 300.

If the recording signal is supplied through a selection of the user selection unit 15, the recording/playing controller 25 outputs the broadcasting signal tuned by the broadcasting signal tuning unit 21 to the storage apparatus 400, and controls the storage apparatus 400 to store the output broadcasting signal therein. Here, if the user selection unit 15 is provided in the display apparatus 100, the recording signal is supplied to the recording/playing controller 25 through the first communication unit 13 of the display apparatus 100 and through the second communication unit 23 of the broadcasting signal tuning apparatus 200. If the user selection unit 15 is provided in the broadcasting signal tuning apparatus 200, the recording signal is supplied to the recording/playing controller 25 without passing an additional communication unit.

If the recording signal is supplied, the recording/playing controller 25 supplies the broadcasting signal and a storage control signal to store the broadcasting signal, to the fourth communication unit 43 of the storage apparatus 400 through the second communication unit 23. Then, the broadcasting signal input through the fourth communication unit 43 is stored in the storage unit 41 of the storage apparatus 400.

Here, the recording/playing controller 25 converts the analog broadcasting signal through at least one of the MPEG codec and the A/D converter, and outputs the converted broadcasting signal to the storage unit 41 of the storage apparatus 400 if the analog broadcasting signal is supplied. If the digital broadcasting signal is supplied, the recording/playing controller 25 preferably stores the digital broadcasting signal in the storage apparatus 400 without an additional conversion. If the broadcasting tuning apparatus 200 comprises a converting unit which converts the digital broadcasting signal, e.g., decodes the digital broadcasting signal, the digital broadcasting signal may be converted.

If the playing signal is supplied and the storage apparatus 400 stores the broadcasting signal therein, the recording/playing controller 25 controls the storage apparatus 400 to store the broadcasting signal received through the broadcasting signal tuning unit 21, and controls the storage apparatus 400 to output the broadcasting signal stored in the storage apparatus 400 to the playing apparatus 300.

If the playing signal is supplied and the storage apparatus 400 stores the broadcasting signal therein, the recording/playing controller 25 controls the storage apparatus 400 to store the broadcasting signal received through the broadcasting signal tuning unit 21, and reads the broadcasting signal stored in the storage apparatus 400 to output the read broadcasting signal to the playing apparatus 300.

If the playing signal is supplied and the storage apparatus 400 does not stores the broadcasting signal therein, the recording/playing controller 25 may control the broadcasting signal received through the broadcasting signal tuning unit 21, to be output to the playing apparatus 300.

Then, the playing unit 31 processes the broadcasting signal to be displayed and outputs the broadcasting signal to the first communication unit 13 of the display apparatus 100 through the third communication unit 33, thereby outputting the broadcasting signal to the display unit 11. Alternatively, the recording/playing controller 25 may read the broadcasting signal processed by the playing unit 31 to be played and supply the broadcasting signal from the third communication unit 33 to the second communication unit 23 and then to the first communication unit 13, thereby outputting an image signal to the display apparatus 100.

### Second Exemplary Embodiment

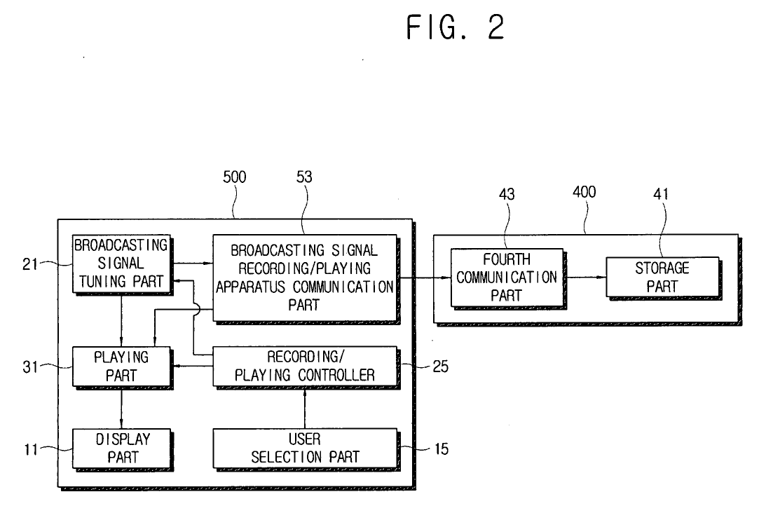

As shown in FIG. 2, a broadcasting signal recording/playing system according to a second exemplary embodiment of the exemplary embodiment of the present invention may comprise a broadcasting signal recording/playing apparatus 500 which has a broadcasting signal tuning unit 21, a playing unit 31 and a recording/playing controller 25, and a storage apparatus 400 which has a storage unit 41. Here, the broadcasting signal recording/playing apparatus 500 may further comprise a display unit 11.

Here, the broadcasting signal tuning unit 21, the playing unit 31, the display unit 11 and the storage unit 41 will not be described as they are the same as that in FIG. 1. Also, the recording/playing controller 25 and the respective communication parts 43 and 53 will not be described here.

If a recording signal is input through a user selection unit 15, the recording/playing controller 25 supplies a broadcasting signal input through the broadcasting signal tuning unit 21 to a fourth communication unit 43 of the storage apparatus 400 through a broadcasting signal recording/playing apparatus communication unit 53. Then, the recording/playing controller 25 controls the storage unit 41 of the storage apparatus 400 to store the broadcasting signal therein.

If a playing signal is input through the user selection unit 15 and the storage unit 41 stores a predetermined image signal therein, the recording/playing controller 25 controls the broadcasting signal input through the broadcasting signal tuning unit 21 to be output to the storage unit 41 of the storage apparatus 400, and controls the storage unit 41 to store the broadcasting signal input through the broadcasting signal tuning unit 21, and supplies the image signal stored in the storage unit 41 to the broadcasting signal recording/playing apparatus 500. Here, the recording/playing controller 25 controls the broadcasting signal from the point of time if it starts being stored in the storage unit 41, i.e., from the recording point of time, to be supplied to the broadcasting signal recording/playing apparatus 500. Accordingly, a viewer may view the broadcasting from the recording point of time.

If the broadcasting signal is supplied through the broadcasting signal recording/playing apparatus communication unit 53, the recording/playing controller 25 supplies the broadcasting signal to the playing unit 31. Then, the playing unit 31 processes the broadcasting signal to be played and outputs it to the display unit 11.

Meanwhile, if the playing signal is input through the user selection unit 15 and the storage unit 41 does not store the predetermined image signal therein, the recording/playing controller 25 outputs the broadcasting signal input through the broadcasting signal tuning unit 21 to the playing unit 31. Then, the playing unit 31 processes the broadcasting signal to be played and outputs it to the display unit 11.

In another exemplary embodiment of the present invention, a broadcasting signal recording/playing system may comprise a broadcasting signal recording/playing apparatus 500 which has a broadcasting signal tuning unit 21, a storage unit 41 and a recording/playing controller 25; and a playing apparatus 300 which has a playing unit 31. Here, one of the broadcasting signal recording/playing apparatus 500 and the playing apparatus 300 may further comprise a display unit 11. Alternatively, a display apparatus 100, which has the display unit 11 may be provided as an additional apparatus.

In another exemplary embodiment of the present invention, a broadcasting signal recording/playing system may comprise a broadcasting signal recording/playing apparatus 500 which has a storage unit 41 and a playing unit 31, and a broadcasting signal tuning apparatus 200 which has a broadcasting signal tuning unit 21 and a recording/playing controller 25. Here, one of the broadcasting signal recording/playing apparatus 500 and the broadcasting signal tuning apparatus 200 may further comprise a display unit 11. Alternatively, a display apparatus 100, which has the display unit 11 may be provided as an additional apparatus.

The broadcasting signal recording/playing system may be variously provided as long as the recording/playing controller 25 is disposed in the same apparatus together with the broadcasting signal tuning unit 21, and controls other apparatuses.

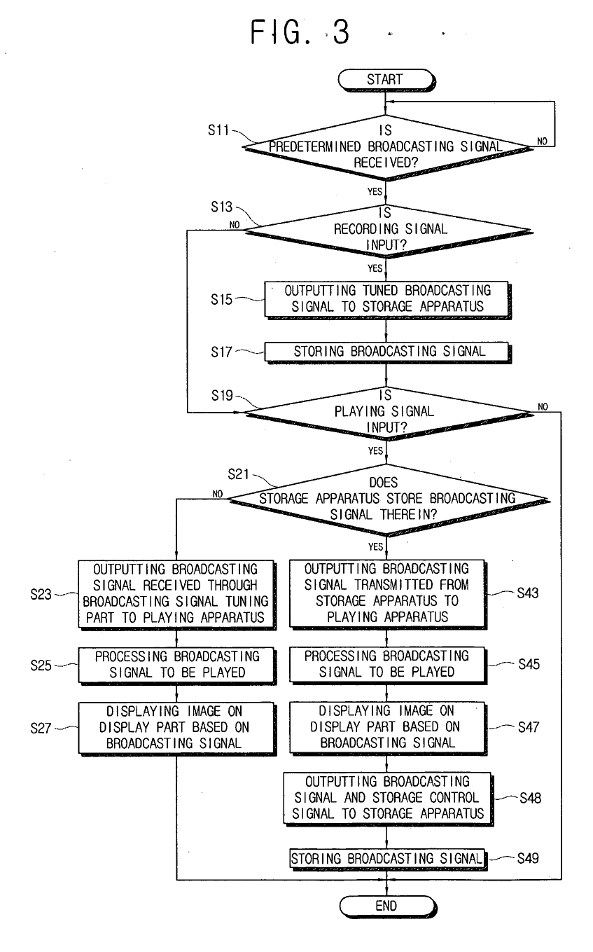

FIG. 3 is a control flowchart of the broadcasting signal recording/playing system which comprises a storage apparatus 400, a playing apparatus 300, the broadcasting signal tuning apparatus 200 and the display apparatus 100. Alternatively, the broadcasting signal recording/playing system may vary.

If the broadcasting signal is received (S11), the broadcasting signal tuning apparatus 200 tunes the broadcasting signal into a predetermined channel according to the predetermined tuning control signal. If the recording signal is input through the user selection unit 15 (S13), the recording/playing controller 25 of the broadcasting signal tuning apparatus 200 outputs the broadcasting signal tuned by the broadcasting signal tuning unit 21, to the storage apparatus 400 (S15). Hereinafter, the recording signal comprises a pause signal as an example of the exemplary embodiment of the present invention.

Here, the recording/playing controller 25 may control the storage apparatus 400 to store the broadcasting signal therein. Then, the storage unit 41 of the storage apparatus 400 stores the broadcasting signal from the point of time if the pause signal is input (S17).

If the predetermined playing signal is input (S19) and the storage apparatus 400 stores the broadcasting signal therein (S21), the recording/playing controller 25 controls the broadcasting signal stored from the time if the pause signal is input, to be output to the playing apparatus 300 from the storage apparatus 400.

As the storage apparatus 400 supplies the broadcasting signal stored therein from the point of time if the pause signal is input, to the broadcasting signal tuning apparatus 200, the broadcasting signal tuning apparatus 200 outputs the broadcasting signal stored in the storage apparatus 400 to the playing apparatus 300 (S43). If the broadcasting signal is input, the playing unit 31 processes the input broadcasting signal to be played by the display apparatus 100 (S45), and outputs the broadcasting signal to the display unit 11 of the display apparatus 100. Then, the display unit 11 displays an image thereon based on the broadcasting signal (S47). If the predetermined playing signal is input (S19) and if the storage apparatus 400 stores the broadcasting signal therein (S21), the recording/playing controller 25 outputs the broadcasting signal and a storage control signal to store the broadcasting signal, to the storage apparatus 400 (S49). Then, the storage unit 41 of the storage apparatus 400 stores the broadcasting signal therein (S49). Here, the operation S48 in which the recording/playing controller 25 outputs the storage control signal to the storage apparatus 400 may be changed with the operation S43 in which the broadcasting signal is output to the playing apparatus 300. Alternatively, the operations 48 and 43 may be simultaneously performed. Accordingly, the operation 49 in which the broadcasting signal is stored in the storage apparatus 400 may be changed with the operation S47 in which the playing apparatus 300 processes the broadcasting signal to be played and the display unit 100 displays the image thereon.

If the predetermined playing signal is input (S19), and if the storage apparatus 400 does not store the broadcasting signal therein (S21), the recording/playing controller 25 outputs the broadcasting signal input through the broadcasting signal tuning unit 21, to the playing apparatus 300 (S23). The playing unit 31 processes the input broadcasting signal to be played by the display apparatus 100 (S25), and then outputs it to the display apparatus 100. The display unit 11 of the display apparatus 100 displays the image thereon based on the broadcasting signal (S27).

As described above, in the broadcasting signal recording/playing system according to the exemplary embodiment of the present invention, the broadcasting signal tuning apparatus 200, the playing apparatus 300, the storage apparatus 400 and the display apparatus 100 may be provided additionally or unit of them may be additionally provided. Also, the recording/playing controller 25 provided in the broadcasting signal tuning apparatus 200 controls the respective apparatuses of the broadcasting signal recording/playing system according to the exemplary embodiment of the present invention, thereby realizing the recording/playing operation without difficulty even if an additional device is provided to record and play the broadcasting signal.

As described above, the exemplary embodiment of the present invention provides a broadcasting signal recording/playing system in which the broadcasting signal tuning apparatus having a signal receiver controls the respective apparatuses if apparatuses recording and playing the broadcasting signal are divided, the broadcasting signal recording/playing apparatus and the broadcasting signal tuning apparatus.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A broadcasting signal recording/playing system, the system comprising:
a storage apparatus which stores a broadcasting signal;
a playing apparatus which processes the broadcasting signal and outputs it; and
a broadcasting signal tuning apparatus comprising a broadcasting signal tuning unit which tunes the broadcasting signal, and a recording/playing controller which outputs the broadcasting signal and a control signal according to a predetermined recording/playing signal to at least one of the storage apparatus and the playing apparatus if the broadcasting signal is received and the predetermined recording/playing signal is supplied.

2. The broadcasting signal recording/playing system according to claim 1, wherein the predetermined recording/playing signal comprises at least one of a recording signal and a playing signal, and wherein
the recording/playing controller outputs the broadcasting signal tuned by the broadcasting signal tuning unit to the storage apparatus, and controls the storage apparatus to store the output broadcasting signal, if the recording signal is supplied.

3. The broadcasting signal recording/playing system according to claim 2, wherein the recording/playing controller controls the storage apparatus to store the broadcasting signal received through the broadcasting signal tuning unit, and controls the storage apparatus to output the broadcasting signal stored in the storage apparatus to the playing apparatus, if the playing signal is supplied and the storage apparatus stores the broadcasting signal.

4. The broadcasting signal recording/playing system according to claim 3, wherein the recording/playing controller controls the storage apparatus to store the broadcasting signal received through the broadcasting signal tuning unit, and reads the broadcasting signal stored in the storage apparatus to output it to the playing apparatus, if the playing signal is supplied and the storage apparatus stores the broadcasting signal.

5. The broadcasting signal recording/playing system according to claim 3, wherein the recording/playing controller outputs the broadcasting signal received through the broadcasting signal tuning unit to the playing apparatus if the playing signal is supplied and the storage apparatus does not store the broadcasting signal.

6. The broadcasting signal recording/playing system according to claim 5, the system further comprising:
a display apparatus comprising a display unit to display an image thereon based on the broadcasting signal processed by the playing apparatus.

7. The broadcasting signal recording/playing system according to claim 6, the system further comprising:
a user selection unit which is provided in at least one of the display apparatus, the storage apparatus, the playing apparatus and the broadcasting signal tuning apparatus, and selects at least one of the recording signal and the playing signal to be supplied to the recording/playing controller.

8. A broadcasting signal tuning apparatus comprising:
a broadcasting signal tuning unit which receives and tunes a broadcasting signal;
a communication unit which communicates with a predetermined external device; and
a recording signal controller which supplies a control signal according to a predetermined recording/playing signal to the predetermined external device through the communication unit if the broadcasting signal is received and the predetermined recording/playing signal is supplied.

9. The broadcasting signal tuning apparatus according to claim 8, wherein the recording/playing signal comprises at least one of a recording signal and a playing signal, and wherein
the recording/playing controller outputs the broadcasting signal and the control signal to store the broadcasting signal, to the predetermined external device if the recording signal is supplied.

10. The broadcasting signal tuning apparatus according to claim 9, wherein the recording/playing controller outputs the broadcasting signal received through the broadcasting signal tuning unit and the control signal to store the broadcasting signal, to the predetermined external device and outputs the control signal to the predetermined external device to play the broadcasting signal stored in the predetermined external device, if the playing signal is supplied and it is determined that the broadcasting signal is stored in the predetermined external device.

11. The broadcasting signal tuning apparatus according to claim 10, wherein the recording/playing controller outputs the broadcasting signal received through the broadcasting signal tuning unit and the control signal to play the broadcasting signal, to the predetermined external device, if the playing signal is supplied and it is determined that the broadcasting signal is not stored in the predetermined external device.

12. The broadcasting signal tuning apparatus according to claim 11, the apparatus further comprising a user selection unit which selects at least one of a recording operation and a playing operation, and wherein
the recording/playing controller receives the recording signal if the recording operation is selected through the user selection unit, and receives the playing signal if the playing operation is selected through the user selection unit.

13. The broadcasting signal tuning apparatus according to claim 11, wherein the communication unit receives the recording/playing signal from the predetermined external device.

14. A broadcasting signal recording/playing apparatus comprising:
a communication unit which communicates with a predetermined external device to store a broadcasting signal;
a broadcasting signal tuning unit which receives and tunes the broadcasting signal;
a playing unit which processes the broadcasting signal and outputs it; and
a recording/playing controller which outputs at least one of a control signal according to a predetermined recording/playing signal and the broadcasting signal, to at least one of the predetermined external device and the playing unit if the broadcasting signal is received and the predetermined recording/playing signal is supplied.

15. The broadcasting signal recording/playing apparatus according to claim 14, wherein the recording/playing signal comprises at least one of a recording signal and a playing signal, and wherein
the recording/playing controller outputs the broadcasting signal and the control signal which controls the predetermined external device to store the output broadcasting signal, to the storage apparatus if the recording signal is supplied.

16. The broadcasting signal recording/playing apparatus according to claim 15, wherein the recording/playing controller outputs the control signal to store the broadcasting signal received through the broadcasting signal tuning unit, to the predetermined external device, and outputs the control signal to output the broadcasting signal stored in the predetermined external device to the playing unit, to the predetermined external device if the playing signal is supplied and the predetermined external device stores the broadcasting signal.

17. The broadcasting signal recording/playing apparatus according to claim 16, wherein the recording/playing controller controls the broadcasting signal received through the broadcasting signal tuning unit to be output to the playing unit if the recording signal is supplied and the predetermined external device does not store the broadcasting signal.

18. A broadcasting signal recording/playing system control method comprising:
receiving a broadcasting signal in a signal tuning unit;
if a recording signal is input, tuning the broadcasting signal with the signal tuning unit, outputting the tuned broadcast signal and storing the broadcasting signal in a storage device;
if a playing signal is input and if the broadcasting signal is stored in a storage device, outputting the broadcasting signal from the storage device to a playing apparatus;
if a playing signal is input and if the broadcasting signal is not stored in a storage device, outputting the broadcasting signal received in the signal tuning unit to the playing apparatus;
processing the broadcasting signal; and
displaying an image on a display unit based on the broadcasting signal.

19. The broadcasting signal recording/playing system control method according to claim 18 further comprising if a playing signal is input and if the broadcasting signal is stored in a storage device, storing the broadcasting signal and a storage control signal to the storage apparatus.
